(19) United States
(12) Patent Application Publication
(10) Pub. No.: US 2008/0091672 A1
(43) Pub. Date: Apr. 17, 2008

(54) PROCESS FOR ANALYZING INTERRELATIONSHIPS BETWEEN INTERNET WEB SITED BASED ON AN ANALYSIS OF THEIR RELATIVE CENTRALITY

(76) Inventor: Peter A. Gloor, Cambridge, MA (US)

Correspondence Address: BARLOW, JOSEPHS & HOLMES, LTD., 101 DYER STREET, 5TH FLOOR, PROVIDENCE, RI, 02903, US

(21) Appl. No.: 11/867,094

(22) Filed: Oct. 4, 2007

Related U.S. Application Data
(60) Provisional application No. 60/852,185, filed on Oct. 17, 2006.

(51) Int. Cl. G06F 17/30

(52) U.S. Cl. 707/5; 707/E17.071

(57) ABSTRACT

A method and system for searching a broad set of electronically based unrelated documents in a manner that identifies the interlinking characteristics between the documents returned via several iterative levels of search results is provided. The interlinking characteristics are then analyzed using a betweenness centrality algorithm to calculate the relative strength of the interlinking relationships in order to identify and create the shortest search paths that lead a user to results having the highest betweeness centrality or having the highest relevance to the stated query.

### CROSS-REFERENCE TO RELATED APPLICATIONS

This application is related to and claims priority from earlier filed U.S. Provisional Patent Application No. 60/852,185, filed Oct. 17, 2006.

### BACKGROUND OF THE INVENTION

The present invention relates generally to a system for measuring, analyzing, and graphically depicting existence and the relative strength of interrelationships between unrelated documents. More specifically, the present invention relates to a system that automatically identifies certain relationships that exist between the various unrelated documents, weights the strength and relevancy of these relationships and then provides an ordered ranking of the documents based on increasing relevancy to a user based search query. For example, search results from a conventional internet search are further mined to locate the existence of underlying interrelationships that are then further analyzed to determine a relative relevancy factor that is used to rank each of the documents returned in the original search results.

In general, the basic goal of any query-based document retrieval system is to find a subset of documents that are highly relevant to the user's input query. It is important and highly desirable, therefore, to provide a user with the ability to identify various bases for relationships between unrelated documents when compiling large quantities of electronic data. Without the ability to automatically identify such relationships, often the analysis of large quantities of data must generally be performed using a manual process. This type of problem frequently arises in the field of electronic media such as on the Internet where a need exists for a user to access information relevant to their desired search without requiring the user to expend an excessive amount of time and resources searching through all of the available information. Currently, when a user attempts such a search, the user either fails to access relevant articles because they are not easily identified or expends a significant amount of time and energy to conduct an exhaustive search of all of the available documents to identify those most likely to be relevant. This is particularly problematic because a typical user search includes only a few search terms and the prior art document retrieval techniques are often unable to discriminate between documents that are actually relevant to the context of the user defined search terms and others that simply happen to include the query term on a random sampling basis.

In this context, typical prior art search engines for locating unstructured documents of interest can be divided into two groups. The first is a keyword-based search, in which documents are ranked on the incidence (i.e., the existence and frequency) of keywords provided by the user. The second is a categorization-based search, in which information within the documents to be searched, as well as the documents themselves, is pre-classified into “topics” that are then used to augment the retrieval process. The basic keyword search is well suited for queries where the topic can be described by a unique set of search terms. This method selects documents based on exact matches to these terms and then refines searches using Boolean operators (and, not, or) that allow users to specify which words and phrases must and must not appear in the returned documents. However, unless the user can find a combination of words appearing only in the desired documents, the results will generally contain an overwhelming and cumbersome number of unrelated documents to be of use.

Several improvements have been made to the basic keyword search. Query expansion is a general technique in which keywords are used in conjunction with a thesaurus to find a larger set of terms with which to perform the search. Query expansion can improve document recall, resulting in fewer missed documents, but the increased recall is usually at the expense of precision (i.e., results in more unrelated documents) due in large part to the increased number of documents returned. Similarly, natural language parsing falls into the larger category of keyword pre-processing in which the search terms are first analyzed to determine how the search should proceed. For example, the query “West Bank” comprises an adjective modifying a noun. Instead of treating all documents that include either “west” or “bank” with equal weight, keyword pre-processing techniques can instruct the search engine to rank documents that contain the phrase “west bank” more highly. Even with these improvements, keyword searches may fail in many cases where word matches do not signify overall relevance of the document. For example, a document about experimental theater space is unrelated to the query “experiments in space” but may contain all of the search terms.

It is important to note that many of the prior art categorization techniques use the term “context” to describe their retrieval processes, even though the search itself does not actually employ any contextual information. U.S. Pat. No. 5,619,709 to Caid et. al. is an example of a categorization method that uses the term “context” to describe various aspects of their search. Caid's “context vectors” are essentially abstractions of categories identified by a neural network; searches are performed by first associating, if possible, keywords with topics (context vectors), or allowing the user to select one or more of these pre-determined topics, and then comparing the multidimensional directions of these vectors with the search vector via the mathematical dot product operation (i.e., a projection). However in operation, this process is identical to the keyword search in which word occurrence vectors are projected in conjunction with a keyword vector. These techniques therefore should not be confused with techniques that actually employ contextual analysis as the basis of their document search engines,

Another technique that attempts to improve the typical results from a key word based searching system is categorization. Categorization methods attempt to improve the relevance by inferring “topics” from the search terms and retrieving documents that have been predetermined to contain those topics. The general technique begins by analyzing the document collection for recognizable patterns using standard methods such as statistical analysis and/or neural network classification. As with all such analyses, word frequency and proximity are the parameters being examined and/or compiled. Documents are then “tagged” with these patterns (often called “topics” or “concepts”) and retrieved when a match with the search terms or their associated topics have been determined. In practice, this approach performs well when retrieving documents about prominent (i.e., statistically significant) subjects. Given the sheer number of possible patterns, however, only the strongest correlations can be discerned by a categorization method. Thus, for searches involving subjects that have not been pre-defined, the subsequent search typically relies solely upon the basic keyword matching method is susceptible to the same shortcomings.

In an effort to further enhance keyword searching and improve its overall reliability and the quality of the identified documents, a number of alternate approaches have been developed for monitoring and archiving the level of interest in documents based on the key word search that produced that document result. Some of these methods rely on interaction with the entire body of users, either actively or passively, wherein the system quantifies the level of interest exhibited by each user relative to the documents identified by their particular search. In this manner, statistical information is compiled that in time assists the overall network to determine the weighted relevance of each document. Other alternative methods provide for the automatic generation and labeling of clusters of related documents for the purpose of assisting the user in identifying relevant groups of documents.

Yet another method that is utilized to facilitate identification of relevant documents is through prediction of relevant documents utilizing a method known as a spreading activation technique. Spreading activation techniques are based on representations of documents as nodes in large intertwined networks. Each of the nodes include a representation of the actual document content and the weighted values of the frequency of each portion of the relevant content found within the document as compared to the entire body of collected documents. The user requested information, in the form of key words, is utilized as the basis of activation, wherein the network is entered (activated) by entering one or more of the most relevant nodes using the keywords provided by the user. The user query then flows or spreads through the network structure from node to node based on the relative strength of the relationships between the nodes.

While spreading activation provides a great improvement in the production of relevant documents as compared to the traditional key-word searching technique alone, the difficulty in most of these prior art predicting and searching methods is that they generally rely on the collection of data over time and require a large sampling of interactive input to refine the reliability and therefore the overall usefulness of the system. As a result, such systems do not reliably work in smaller limited access networks. For example, when a limited group of people is surveyed to determine particular information that may be relevant to them, the survey in itself is generally limited in scope and breadth. Further, the analysis of the survey needs to be performed without then requesting that the participants themselves pour over the survey data to draw the connections and relevant interrelationships.

Most of the aforementioned systems were principally concerned with a picture of the overall relationship that existed throughout the entire set of documents. While this allowed various clustered hubs to be identified, there exists a need to further drill down into that data and mine it based on relationships between individual actors and or based on the relative frequency of the common terms that are contained within documents passing between actors.

In view of the foregoing, there is a need for an automatic system for analyzing discrete groups of unstructured documents in order to identify relevant documents and to create a visual depiction of the interrelationships between the various relevant documents that allows them to be correlated in a meaningful manner. There is a further need for an automatic system for analyzing discrete groups of relevant documents that measures and provides a visual depiction of the interrelationships between the documents and the strengths of those interrelationships thereby identifying the most relevant search results based on a subject query. In other words, there is a need for an ability to apply a degree of separation search to a set of web based documents to determine their overall relevance to one another thereby identifying hubs of particularly high relevance.

### BRIEF SUMMARY OF THE INVENTION

In this regard, the present invention provides a system for searching a broad set of electronically based unrelated documents in a manner that identifies the interlinking characteristics between the documents returned via several iterative levels of search results. The interlinking characteristics are then analyzed using a betweenness centrality algorithm to calculate the relative strength of the interlinking relationships in order to identify and create the shortest search paths that lead a user to results having the highest betweeness centrality or having the highest relevance to the stated query. Using the search algorithm of the present invention, connections between the interlinked sets of documents are analyzed to determine their contextual strength in order to quickly and easily identify underling similarities and relationships that may not be immediately visible upon the face of the base documents.

The present invention provides a system wherein the initial search is performed to generate first level results and those results are mined to identify a second (and subsequent) level search result containing all of the pages that are linked to from the set of results that are identified in the previously search level. All of the iterative search results are then collected and represented as a plurality of nodes in a network matrix. The documents that are to be analyzed are each added into the overall network (corpus) wherein each document is added at a discrete node corresponding to the document. These nodes are referred to as a document node. As the documents are added to the corpus, a stepwise refinement process is utilized that creates a list of the interlinking data between each of the nodes in the result in order to connect that document into the network. Then using the interlinking information in the network, the betweenness for each node is calculated such that the betweeness is a measure of the centrality of a node in a network. It may be characterized loosely as the number of times that a node needs a given node to reach another node. It is usually calculated as the fraction of shortest paths between node pairs that pass through the node of interest. Accordingly, betweenness ranges from 0, for nodes that are totally peripheral, to 1, for nodes that are on all shortest paths.

The power of the system of the present invention is derived from the ability to produce a search result that identifies the most highly relevant search results across an electronic network based on a calculation of the strength of the ties between discrete search results based on a weighted average of the number of links that exist between the page of interest and all of the other search results that were identified as marginally relevant.

The system of the present invention can further be employed in a collaborative search fashion. In this regard, the user's search strategy or the history of the pages visited over the course of the search are used to further refine the overall search strategy and assist in calculating the must productive path to follow next. In other words, the overall search path history is employed in the betweeness calculation in order to determine the most likely high betweeness based on the entire search progress and not based only on the current browsing position of the user at the given time. By having access to a growing context of a search query, the system of the present invention is capable of making educated guesses about where a user might want to go next.

It is therefore an object to provide a method and system for analyzing and visually depicting the strength and relevance of the underlying relationships between various unstructured documents. It is a further object of the present invention to provide a visualization system for categorizing interrelationships between various unstructured documents based on a betweeness centrality principal in a manner that assists in identifying the relative strengths of each of the interrelationships. It is still a further object of the present invention to provide a visualization method for graphically depicting the relative strength and context of the interrelationships between unstructured documents that produces Internet query based search results that are highly relevant as compared to prior art results.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is flow chart depicting a first embodiment of the method of the present invention;

FIG. 2 is flow chart depicting an alternate embodiment of the method of the present invention;

FIG. 3 is flow chart depicting a second alternate embodiment of the method of the present invention;

FIG. 4 is a visual depiction of the results returned in the initial query step of the present invention;

FIG. 5 is a visual depiction of the results of the query after the betweeness centrality of the results has been calculated; and

FIG. 6 is a visual depiction of the results of a linked combined query after the betweeness centrality of the results has been calculated.

### DETAILED DESCRIPTION OF THE INVENTION

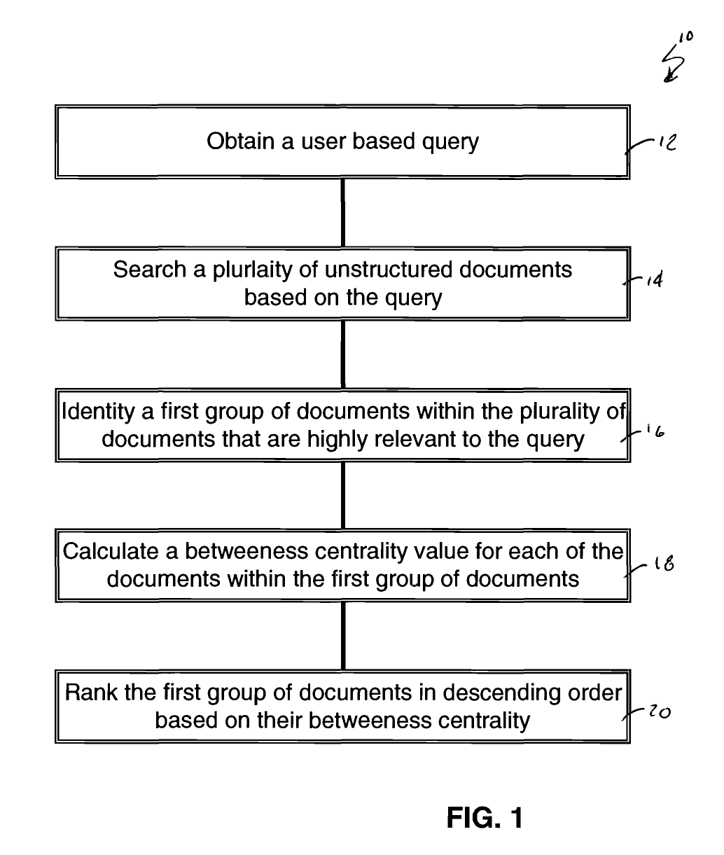

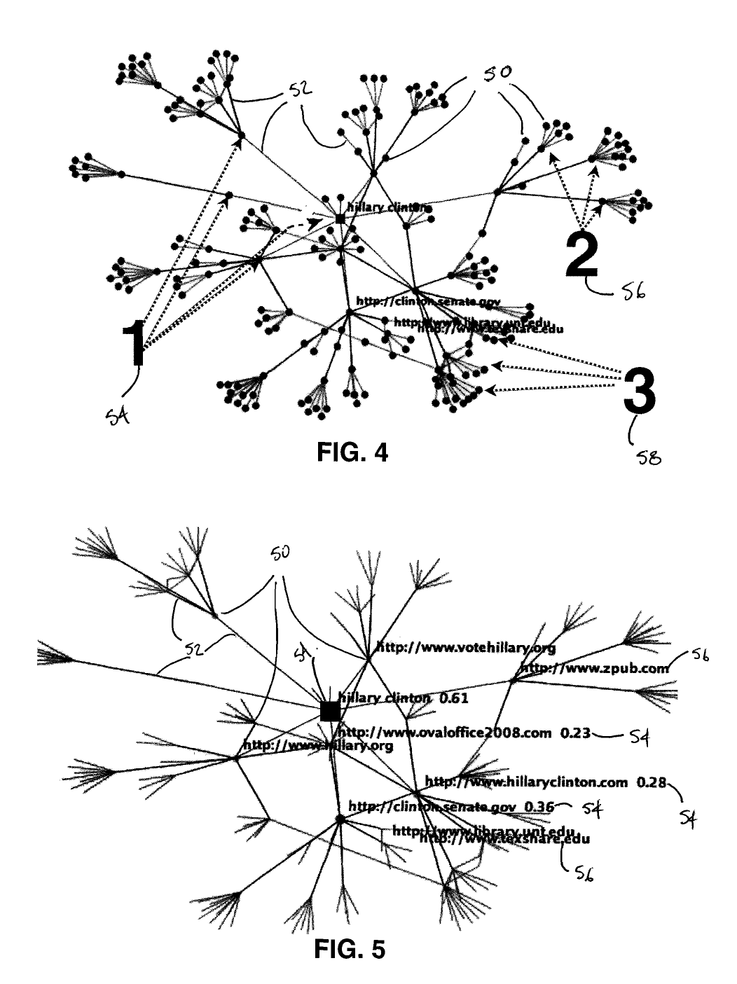

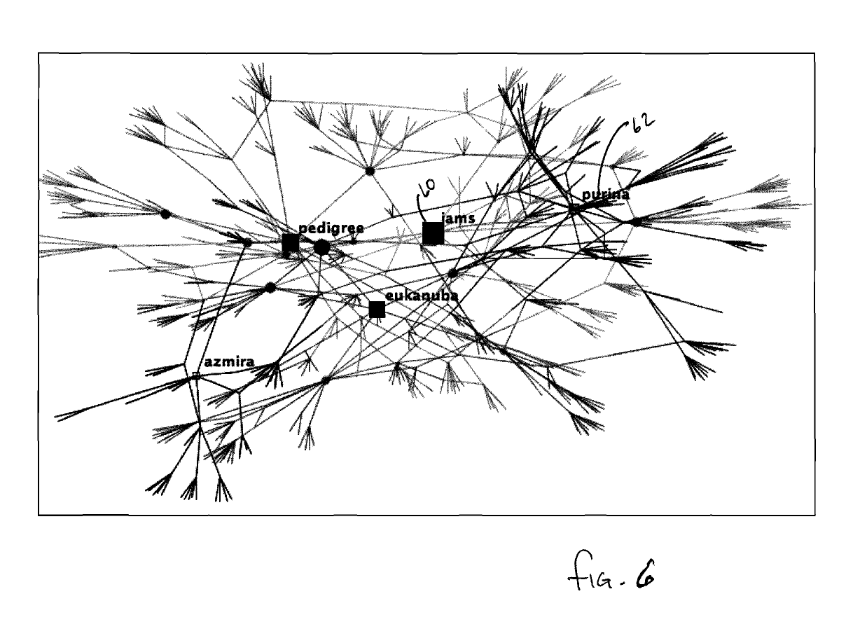

Now referring to the drawings, the method of the present invention for analyzing a plurality of unstructured documents in order to identify a discrete group of those documents that have a particularly high degree of relevancy to a user based query is shown and generally illustrated at the flow charts in FIGS. 1-3. Further, a method of providing a visual depiction of the interrelationships and the strength of those relationships as compared to the user-based query is illustrated at FIGS. 4 and 5.

Turning to FIG. 1, in the most general embodiment, the present invention provides a method 10 for analyzing and ranking interrelationships that exist within a plurality of unstructured documents to identify documents having a high relevancy to a user based query. In operation, the method 10 first provides for obtaining a user-based query 12. Next, the user-based query is employed to search a plurality of unstructured documents 14 in order to identify at least a first group of documents that are most highly relevant to the user based query 16. Once the first group of documents has been identified 16, a betweeness centrality ranking is calculated for each of the documents 18 so that each of those documents can be ranked in descending order relative to one another based on their betweeness centrality value 20.

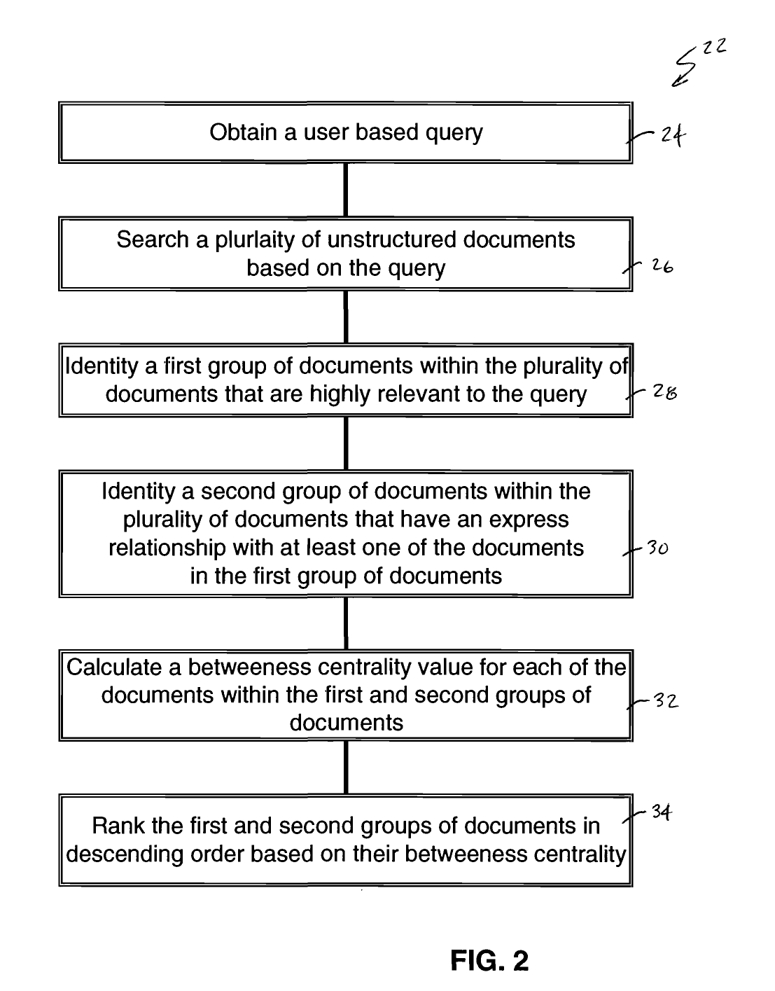

FIG. 2 depicts a second embodiment method 22 for the present invention wherein the scope of the search result is expanded more broadly to capture additional unstructured documents that may be relevant to the user based query. In the context of this embodiment, the method 22 provides for obtaining a user-based query 24 as provided for above. Next, the user-based query is employed to search a plurality of unstructured documents 26 and to identify a first group of documents 28 that are most highly relevant to the user based query 24. Once the first group of documents has been identified 28, a second group of documents are identified wherein each of the documents within the second group of documents have an express relationship with at least one of the documents in the first group of documents 30. In this regard such an express relationship in the context of Internet web pages may be a direct link between the pages for example. A betweeness centrality ranking is then calculated 32 for each of the documents within the first and second groups so that each of the documents can be ranked in descending order 34 relative to one another based on their betweeness centrality value.

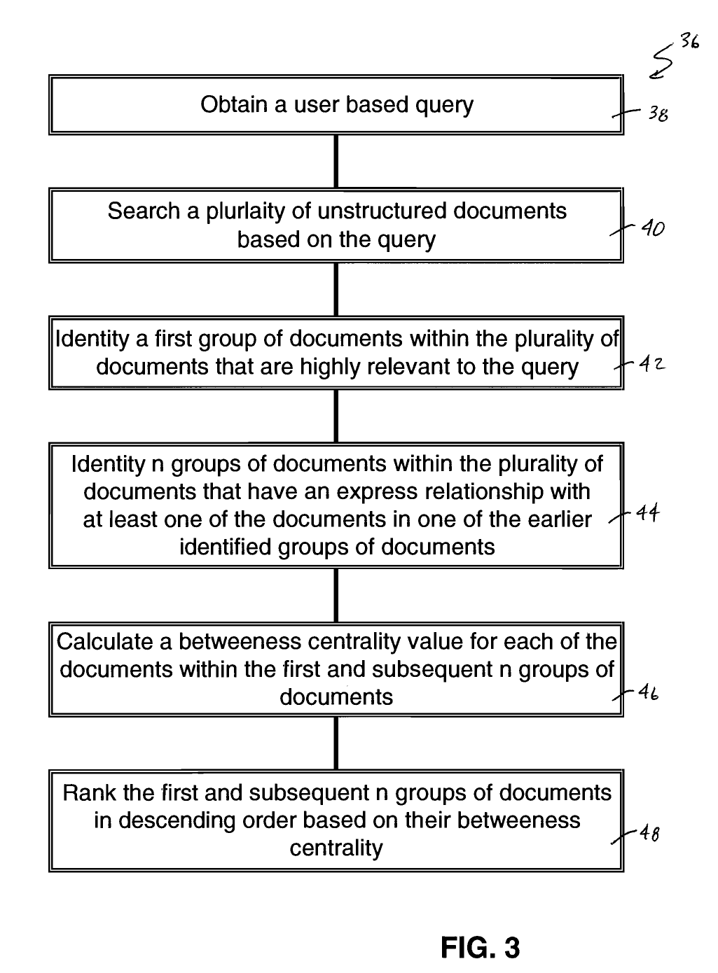

It should be appreciated by one skilled in the art that the method of the present invention can be extended to as many degrees of separation as desired by the user thereof such as is depicted in the embodiment of FIG. 3. As depicted at FIG. 3, the method 36 provides for obtaining a user-based query 38 as described in the earlier embodiments above. Next, the user-based query is employed to search a plurality of unstructured documents 40 and to identify a first group of documents that are most highly relevant to the user based query 42. Once the first group of documents has been identified 42, n additional groups of documents are identified wherein each of the documents within n additional groups have an express relationship with at least one of the documents in one of the earlier identified groups of documents 44. In this regard the value of n is equal to the desired degree of separation to which the user wishes the query to proceed. Further, n may be equal to an integer constant that is greater than or equal to 0. This allows the degree of separation to be limited to a single level of document results should n equal 0, an infinite degree of separation for extremely large values of n of any value therebetween. A betweeness centrality ranking is then calculated for each of the documents within the first and n subsequent groups 46 so that each of the documents can be ranked in descending order relative to one another based on their betweeness centrality value 48.

It is known in the art that the general concept of betweenness centrality has originally been defined in the context of social network analysis. In such a context, it measures the knowledge flow in a social network as a function of the shortest paths. In other words, betweeness centrality looks at the percentages of all shortest paths in a network that go through a given node. Accordingly, the concept of betweenness is essentially a metric for measuring of the centrality of any node in a given network. It may be characterized loosely as the number of times that a node needs a given node to reach another node. In practice, it is usually calculated as the fraction of shortest paths between node pairs that pass through the node of interest using the following function:

$${b}_{k} = {\sum }_{i , j} \frac{{g}_{ikj}}{{g}_{ij}}$$

where gᵢⱼ is the number of shortest paths from node i to node j, and gᵢₖⱼ is the number of shortest paths from i to j that pass through k. Betweenness ranges from 0, for nodes that are totally peripheral, to 1, for nodes that are on all shortest paths.

Within the scope of the present invention, the desired focus of the method of ranking unrelated documents is towards identifying and ranking a plurality of internet web based documents based on their relevancy to a user based query. In this regard, such unrelated documents may be selected from the group consisting of: documents, discrete elements of data, email communications, Web pages, online forum posts, online blog posts and actors that create any of the foregoing. More preferably, the unrelated documents are general internet based web content or web pages.

In the most general terms, the present invention provides for performing a degree of separation search based on a user-defined scope or degree of separation limit. Once the results of the degree of separation search are returned, they are analyzed to determine the existing interrelationships that exist between all of the results. Then the results and their interrelationships are again evaluated using a betweeness centrality algorithm to provide each result with a betweeness centrality value that is relative globally to the entire body of results returned. Finally, the results are ranked based on the strength of their betweeness centrality values.

It is further possible within the scope of the present invention to employ the presently disclosed method to perform parallel queries for a broad general category or two different user based search queries. In all regards, the two parallel searches are performed as described above. In the end, the results from the parallel searches are then all brought together and ranked as a single group based on their betweeness centrality values. In such a parallel search the query results need to be connected in some manner to allow the betweenness to be calculated and to provide an ability to identify the shortest path in and among all of the results. In the general sense, a search for Iams® 60 brand pet food and Purina® 64 are interlinked based on the fact that they are both pet foods. The parallel queries for Iams® and Purina® as a result of being among the most highly-ranked Web sites in response to a Web query are also extremely well linked, and will therefore create the necessary connection between the different query results. In other words, even should these parallel queries be conducted separate and apart from one another, they end up being ranked together because of the natural existence of interlinking within the web structure that also creates high betweeness among the search results.

Once the calculation is completed as described above, the present invention also provides for the results to be arranged in a visual array in order to graphically depict the most relevant results and the strength of their relevancy. As provided at FIGS. 4 and 5, the visual array consists of an array of nodes 50 wherein each of the nodes 50 depicts one of the documents in the query results. Within the array of nodes 50, it can be seen that there is an array of lines 52 wherein the lines 52 extend between two of the nodes 50 within the array of nodes 50. Each of the lines 52 connecting the nodes 50 in turn represents an express relationship between the two nodes 50. In the case of internet web searching, each node 50 represents a web page and each line 52 represents a link that exists between the pages. The visual array it ultimately arranged in a manner where the positioning of the nodes 50 within said visual array is based on the relative betweeness centrality value calculated for each of said documents corresponding to each of said nodes 50. It can be further seen in FIG. 4, that the level-1 nodes 54 are the ones connected directly to the query, i.e. the original search results. Level-2 nodes 56 are the most highly ranked search results returned by the interrelationship or “link” query, to each of the top ten level-1 nodes 54. Level-3 nodes 58 are the results returned by the “link” queries of each of the level-2 nodes 56.

Subsequently, FIG. 5 gives a visual overview of the betweenness of each of the level-1 nodes 54 and level-2 nodes 56. The more links a node has pointing to it, the more between it is. For example the node labeled http://clinton.senate.gov is linked by a group of level 2 nodes which themselves are linked by groups of level-3 nodes. This indicates that the node http://clinton.senate.gov will have fairly high betweenness itself. It can be seen that the betweenness values range from 0, for nodes which are totally peripheral, to 1, for nodes which are on all shortest paths. The most between node in FIG. 5 is the search query “Hillary Clinton” itself, with a value of 0.61. The second most between node is indeed, as FIG. 5 illustrates, http://clinton.senate.gov with a betweenness value of 0.36. Some other high-betweenness nodes are www.ovaloffice2008.com and www.hillaryclinton.com.

For the purpose of illustration, the present invention for example can be used to analyze the results produced in using a conventional Internet search such as is done through Google®. A user performs a search by inputting search terms into the Google® search interface. Google® then sorts the search results by its own patented “Page Rank” algorithm, which looks at what web pages link back to a particular page. It also weights the links to the page by the page rank of the originating page. In terms of social network analysis Google® measures the in-degree of a page. In other words, Google® determines the number of incoming links. Page rank is a global algorithm, because it factors in all the nearest neighbors of the page it is measuring. It includes page-rank of the neighbors, weighting incoming links higher from sites that themselves have a high page rank. While this serves to identify some of the pages of relevance, the Google® search results do not necessarily have the highest betweenness centrality. In this context, it is important to note that frequently, a node that has a high page rank will also have high betweenness, but this is not necessarily the case. In particular, Google's® PageRank offers one static number for a Web site, independent of each query. Our algorithm might give a different value for a Web site depending on the search query. For example the Web Site ovaloffice2008.com has a Google Page Rank of 5 (out of 10), but will have top betweenness with our algorithm in a query for a presidential contender. The present invention then takes the search results returned in a traditional search and builds a network map displaying the linking structure of a list of web sites returned in response to a Google® query.

For example, a search to get the betweenness of “Hillary Clinton” works as follows:

1. Starts by entering the search string “Hillary Clinton” into Google®.

2. Take the top ten, or another small number of Web sites returned to query “Hillary Clinton”.

3. Get the top ten, or another small number of Web sites pointing to each of returned Web sites in step 2 by executing a “link:URL” query, where URL is one of the top ten Web sites returned in step 2. The Google “link” query returns the “significant” Web sites linking to a specific URL. For Google® “significant” means that the linking Web sites themselves are linked by other Web sites with a page rank larger than 0.

4. Get the top ten Web sites pointing to each of returned Web sites in step 3. Repeat step 4 up to desired degree of separation from the original top ten Web sites collected in step 2. Usually it is sufficient, however, to stop here at step 4 The system can then be extended to compare, for example, betweeness of searches for “Hillary Clinton”, “Rudolph Giuliani”, “John McCain”, and “John Edwards” to obtain the most significant candidates for US president in 2008.

Once the results are returned, the betweeness of each of the identified results is calculated and the results are bound to the network map based on the betweeness values. As a result, the pages having the highest degree of relevancy to the user query will have the highest betweeness values and can then be prioritized for analysis as needed in the original query.

It should be appreciated that this visualization can be done using a snapshot in time or could be formed as a temporal visualization. In other words, the same search can be re-executed as a function of time in order to visually depict changes in the betweeness centrality of the relevant documents of interest over time. Further, it should be appreciated that the weighting factor can be changed dynamically at any point of the temporal visualization process.

It can therefore be seen that the present invention provides a unique system that has broad applicability in greatly enhancing the results returned in a user based search through a body of unstructured documents. The ranking of each document from a traditional degree of separation search is further enhanced by analyzing their interlinking structure and their relative betweeness centrality as compared to the global selection of all of the returned results. Each document result is then bound to a visual display network that further serves to enhance the users ability to identify the various interrelationships and strengths thereof between the documents. For these reasons, the present invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for analyzing and ranking interrelationships that exist within a plurality of unstructured documents to identify documents having a high relevancy to a user based query, the method comprising the steps of:
obtaining a user based query;
searching said plurality of unstructured documents via said user based query;
identifying at least first group of documents from within said unstructured documents, said first group of documents being most highly relevant to said user based query;
calculating a betweeness centrality value ranking for each of the documents within said first group of documents; and
ranking said first group of documents in descending order based on their betweeness centrality value.

2. The method of claim 1, further comprising:
identifying a second group of documents, each of said documents within said second group of documents having an express relationship with at least one of said documents in said first group of documents;
calculating a betweeness centrality value for each of the documents within said second group of documents; and
ranking said first and second group of documents in descending order based on their betweeness centrality value.

3. The method of claim 1, further comprising
identifying n groups of documents, each of said documents within said n groups of documents having an express relationship with at least one of said documents in an earlier identified group of documents, wherein n is equal to a desired degree of separation;
calculating a betweeness centrality value for each of the documents within said n groups of documents; and
ranking said n groups of documents in descending order based on their betweeness centrality value.

4. The method of claim 1, wherein said documents are web pages.

5. The method of claim 1, wherein said step of searching said plurality of unstructured documents comprises:
performing a traditional web search using an internet search engine.

6. The method of claim 1, wherein said documents are selected from the group consisting of: documents, discrete elements of data, email communications, Web pages, online forum posts, online blog posts and actors that create any of the foregoing.

7. The method of claim 1, wherein said documents are arranged in a visual array, wherein said visual array further comprises:
an array of nodes, wherein each of said nodes depicts each of said documents; and
an array of lines, each of said lines extending between two of said nodes within said array of nodes, wherein each of said lines represents an express relationship between said two nodes.

8. The method of claim 7, wherein the positioning of said nodes within said visual array is based on the relative betweeness centrality value calculated for each of said documents corresponding to each of said nodes.

9. The method of claim 7, wherein said documents are web pages and said express relationships are links between web pages

10. The method of claim 1, further comprising:
obtaining a second user based query;
searching said plurality of unstructured documents via said second user based query;
identifying at least a second group of documents from within said unstructured documents, said second group of documents being most highly relevant to said second user based query;
calculating a betweeness centrality value ranking for each of the documents within said second group of documents; and
ranking said second group of documents relative to one another and said first group of documents in descending order based on their betweeness centrality value.

11. The method of claim 10, wherein said step of calculating betweeness centrality is repeated after a fixed period of time to create a temporal depiction of the changes in betweeness centrality over time.

12. A method for analyzing and ranking interrelationships that exist within a plurality of internet based documents to identify documents having a high relevancy to a user based query, the method comprising the steps of:
obtaining a user based query;
searching said plurality of internet based documents via an internet search engine using said user based query;
identifying a first group of documents from within said internet based documents, said first group of documents being most highly relevant to said user based query;
identifying n additional sets of documents each of said documents within said n groups of documents are directly linked to at least one of said documents in an earlier identified group of documents, wherein n is equal to a desired degree of separation;
calculating a betweeness centrality value ranking for each of the documents within said first group of documents and said n additional sets of documents; and
ranking said first group of documents said n additional sets of documents in descending order based on their betweeness centrality value.

13. The method of claim 12, wherein n is a value greater than or equal to 0.

14. The method of claim 12, wherein said internet based documents are selected from the group consisting of: Web pages, online forum posts, online blog posts and actors that create any of the foregoing.

15. The method of claim 12, wherein said internet based documents are arranged in a visual array, wherein said visual array further comprises:
an array of nodes, wherein each of said nodes depicts each of said internet based documents; and
an array of lines, each of said lines extending between two of said nodes within said array of nodes, wherein each of said lines represents a direct link between said internet based documents represented by said two nodes.

16. The method of claim 15, wherein the positioning of said nodes within said visual array is based on the relative betweeness centrality value calculated for each of said internet based documents corresponding to each of said nodes.

17. The method of claim 12, further comprising:
obtaining a second user based query;
searching said plurality of internet based documents via said second user based query;
identifying at least a second group of documents from within said unstructured documents, said second group of documents being most highly relevant to said second user based query;
calculating a betweeness centrality value ranking for each of the documents within said second group of documents; and
ranking said second group of documents relative to one another and relative to said first and n groups of documents in descending order based on their betweeness centrality value.

18. The method of claim 12, wherein said step of calculating betweeness centrality is repeated after a fixed period of time to create a temporal depiction of the changes in betweeness centrality over time.
